(19) United States
(12) Patent Application Publication
(10) Pub. No.: US 2008/0077061 A1
(43) Pub. Date: Mar. 27, 2008

(54) KNEADING AND ROLLING ROBOTIC MASSAGE DEVICE

(76) Inventor: Hans Dehli, San Clemente, CA (US)

Correspondence Address: CHRISTIE, PARKER & HALE, LLP, PO BOX 7068, PASADENA, CA, 91109-7068, US

(21) Appl. No.: 11/859,252

(22) Filed: Sep. 21, 2007

Related U.S. Application Data
(60) Provisional application No. 60/826,511, filed on Sep. 21, 2006.

(51) Int. Cl. A61H 7/00; A61H 15/00

(52) U.S. Cl. 601/118; 601/115; 601/134

(57) ABSTRACT

A massaging apparatus has a frame having a curved track including a plurality of curves; a mount engaging the curved track; a massage head coupled to the mount; and a motor adapted for moving the mount along the curved track. The mount engages the curved track such that movement of the mount along the curved track translates into a movement of the massage head that depends on the plurality of curves of the curved track.

### RELATED APPLICATIONS

This application claims priority to and the benefit of U.S. Provisional Application No. 60/826,511, filed Sep. 21, 2006, the entire contents of which are incorporated herein by reference.

### FIELD OF THE INVENTION

The present invention relates generally to an improved kneading and rolling robotic massage device.

### BACKGROUND OF THE INVENTION

Massaging devices have been incorporated into custom built massage chairs to perform a massaging action on the user sitting in the chair. Such chairs perform an automated massaging action for the user so that the user can enjoy a massage without having to travel to a spa or pay for an expensive massage treatment. A typical massaging device fitted in the back of a massage chair includes a track, two eccentric massaging wheels, and a driving mechanism slidably coupled to the track. A first motor moves the driving mechanism up and down along the track, which is typically aligned with the user's spine. As the first motor moves the driving mechanism up and down along the track, the massaging wheels move up and down on either side of the user's spine. The driving mechanism itself contains a second motor that spins or rotates the massaging wheels. Thus, the user feels the spinning wheels moving up and down along the tracks on either side of the user's spine. The massage chair also includes a controller that provides the appropriate signal to the mechanism for driving the mechanism back and forth along the rails. The controller is coupled to a selection device that the user can operate to turn the driving mechanism on and off and to select the speed of the movement and rotation of the massaging wheels. Depending on the type of the massage being performed, the two massage wheels may be eccentrically mounted, and/or they may be mounted such that they are not parallel to each other.

This typical massage chair has several deficiencies. First, it requires two motors, one to move the drive mechanism up and down the track, and a second motor to spin or rotate the massage wheels. This device can be complex and relatively noisy. Electrical wiring can become tangled or chaffed during movement of the driving mechanism. The second motor is also prone to failure as it is a small motor that meets significant resistance as it moves. Second, the massage chair is costly to manufacture due to the number of moving and electrical components within the drive mechanism. Third, with time, wear of the guide wheels causes the drive mechanism and massaging wheels to rattle during operation. Finally, such a system may be relatively heavy, utilizing a sturdy supporting chair with a thick back section to accommodate it.

Accordingly, there is still a need for an improved massage chair that remedies some or all of the deficiencies of the prior art.

### SUMMARY

In an embodiment, a massaging apparatus has a frame having a curved track including a plurality of curves; a mount engaging the curved track; a massage head coupled to the mount; and a motor adapted for moving the mount along the curved track. The mount engages the curved track such that movement of the mount along the curved track translates into a movement of the massage head that depends on the plurality of curves of the curved track.

In an embodiment, a massaging apparatus includes a frame comprising a curved track having a curved pattern; a massage assembly coupled to a massage head; and a motor coupled to the massage assembly to move the massage assembly along the curved track. The massage assembly and the massage head are coupled together such that the movement of the massage assembly along the curved track causes a corresponding movement of the massage head that correlates to the curved pattern of the curved track.

In an embodiment, a massage pad has a pad; a frame having a curved track including a plurality of curves, wherein the pad supports the frame; a mount engaging the curved track; a massage head coupled to the mount; and a motor adapted for moving the mount along the curved track. The mount engages the curved track such that movement of the mount along the curved track translates into a movement of the massage head that depends on the plurality of curves of the curved track.

In an embodiment, a massage chair includes a backrest portion; a seat portion; a frame comprising a curved track having a curved pattern, wherein the backrest portion supports the frame; a massage assembly coupled to a massage head; and a motor coupled to the massage assembly to move the massage assembly along the curved track. The massage assembly and the massage head are coupled together such that the movement of the massage assembly along the curved track causes a corresponding movement of the massage head that correlates to the curved pattern of the curved track.

In an embodiment, a massaging apparatus includes a frame having a massage track; a massage assembly engaging the massage track and having at least one massage head; means for moving the massage assembly along the massage track in a first direction; and means for rotating the massage head in a second direction offset from the first direction. The means for rotating includes a plurality of curves in the massage track, and the means for moving includes a threaded shaft coupled to the massage assembly and to a motor for rotating the threaded shaft to move the massage assembly.

### BRIEF DESCRIPTION OF THE DRAWINGS

Novel features and advantages of the present invention will be better understood by reference to the following detailed description when considered in conjunction with the accompanying drawings wherein:

FIG. 1A is a front perspective view of a massage mechanism according to an exemplary embodiment of the invention;

FIG. 1B is a rear perspective view of the massage mechanism of FIG. 1A;

FIG. 1C is a front perspective view of the massage mechanism of FIG. 1A;

FIG. 1D is a top perspective view of the massage mechanism of FIG. 1A;

FIG. 1E is a bottom perspective view of the massage mechanism of FIG. 1A;

FIG. 1F is a front schematic view of a massage head and arm according to an exemplary embodiment of the invention;

FIG. 1G is a side perspective view of a back pad incorporating a massage mechanism according to an exemplary embodiment of the invention;

FIG. 1H is a front elevational view of a massage chair incorporating a massage mechanism according to an exemplary embodiment of the invention;

FIG. 2A is a top plan view of a massage mechanism according to an exemplary embodiment of the invention;

FIG. 2B is a side perspective view of the massage mechanism of FIG. 2A with massage arms and heads removed for clarity;

FIG. 2C is a corner perspective view of the massage mechanism of FIG. 2B;

FIG. 2D is a side perspective view of a massage mechanism according to an exemplary embodiment of the invention, in a first position;

FIG. 2E is a top plan view of a massage mechanism according to an exemplary embodiment of the invention, in a first position;

FIG. 2F is a side perspective view of a massage mechanism according to an exemplary embodiment of the invention, in a second position;

FIG. 2G is a top plan view of a massage mechanism according to an exemplary embodiment of the invention, in a second position;

FIG. 3A is a corner perspective view of a massage mechanism according to an exemplary embodiment of the invention;

FIG. 3B is a corner perspective view of a massage mechanism according to another embodiment of the invention;

FIG. 3C is an enlarged view of the massage mechanism of FIG. 3B; and

FIG. 4 is a schematic top view of a massage mechanism according to another embodiment of the invention.

### DETAILED DESCRIPTION

The detailed description set forth below in connection with the appended drawings is intended as a description of the presently preferred embodiments of a kneading and rolling robotic massage device provided in accordance with the present invention and is not intended to represent the only forms in which the present invention may be constructed or utilized. The description sets forth the features of the present invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like elements or features.

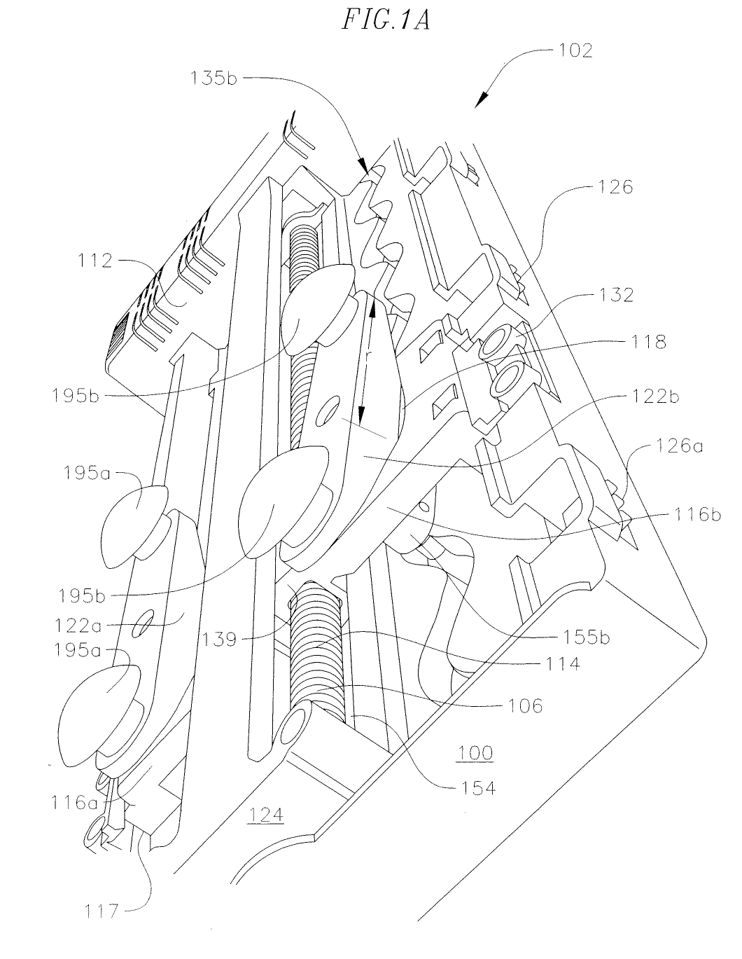

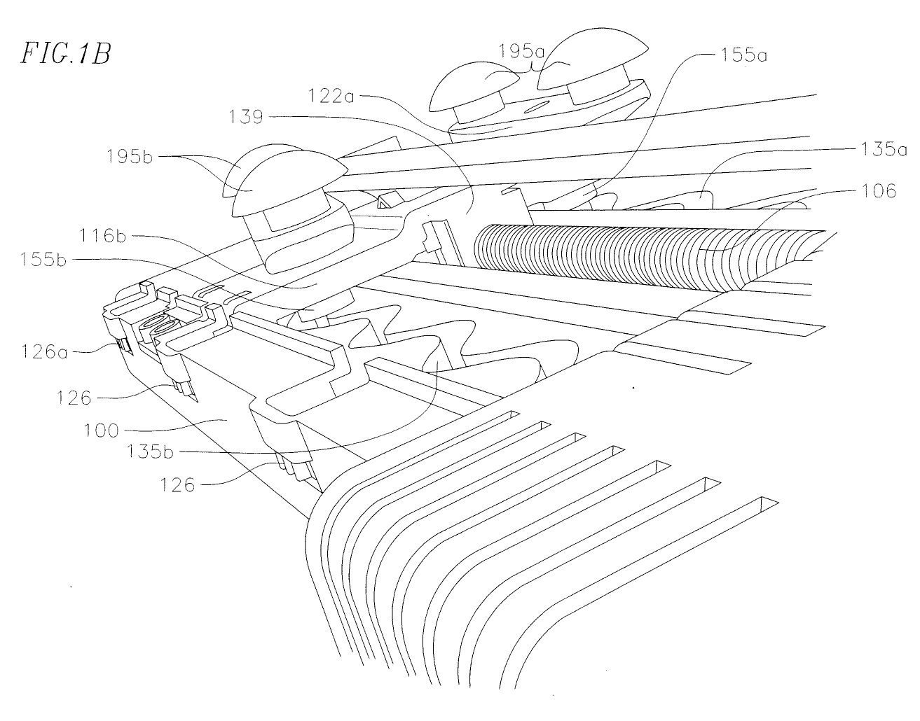

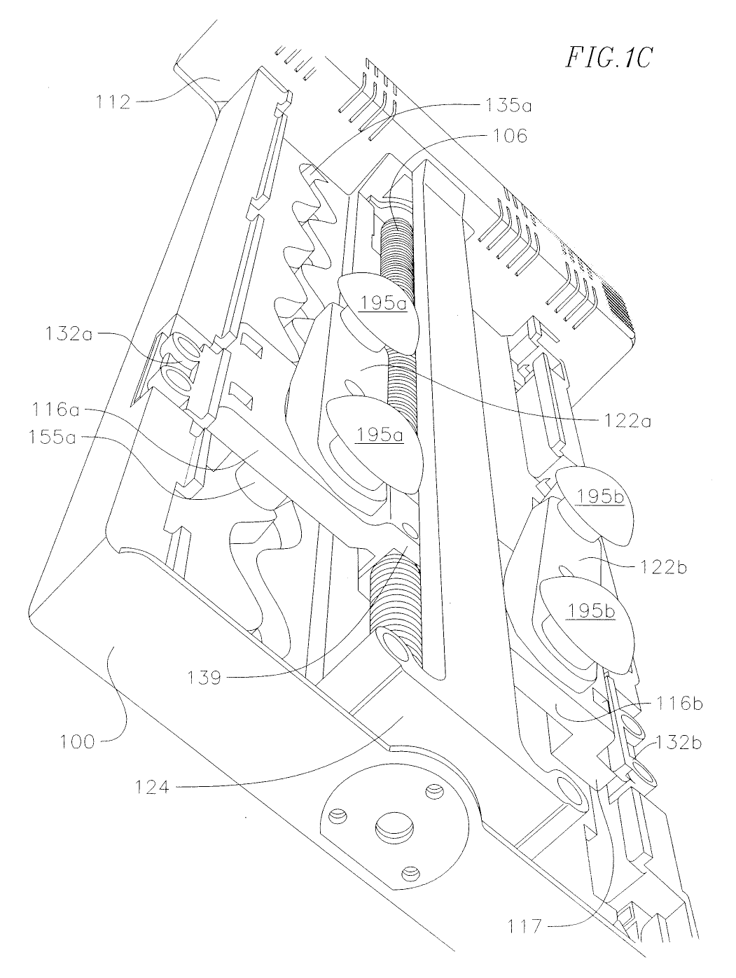

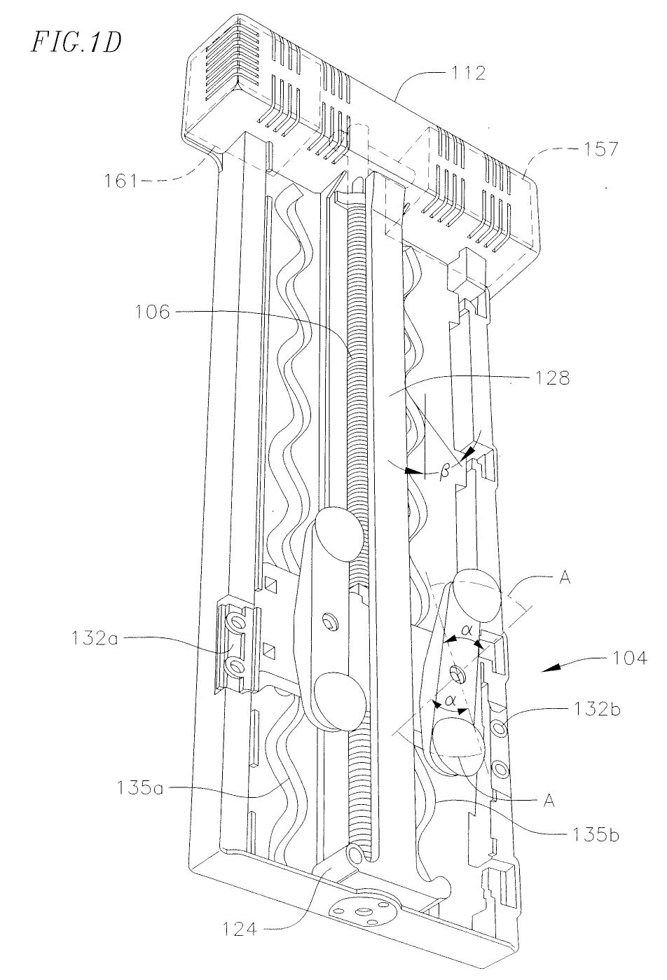

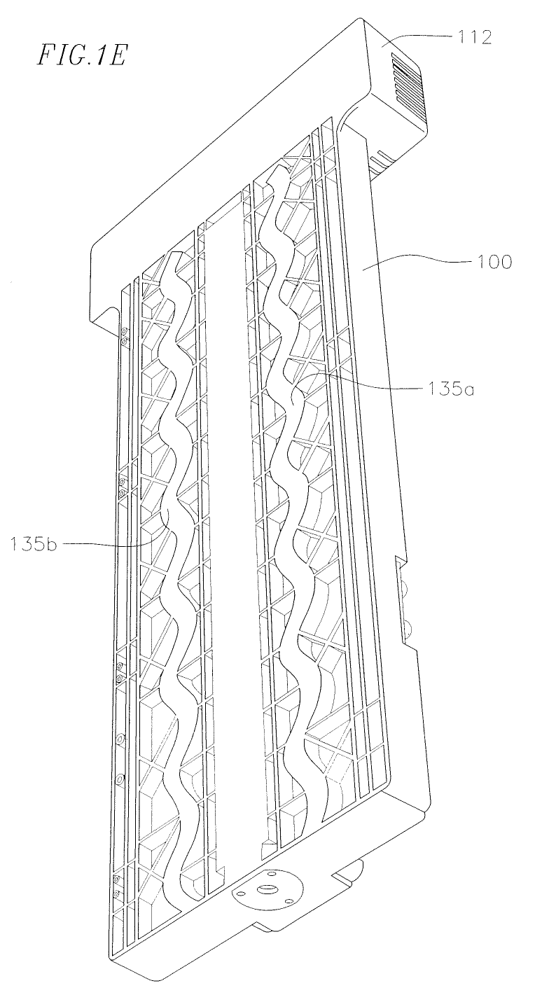

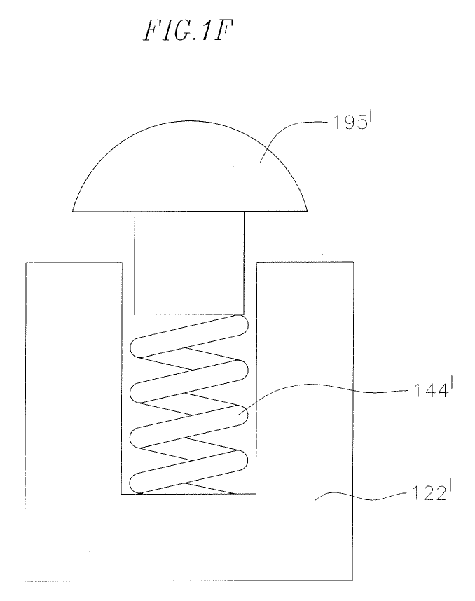

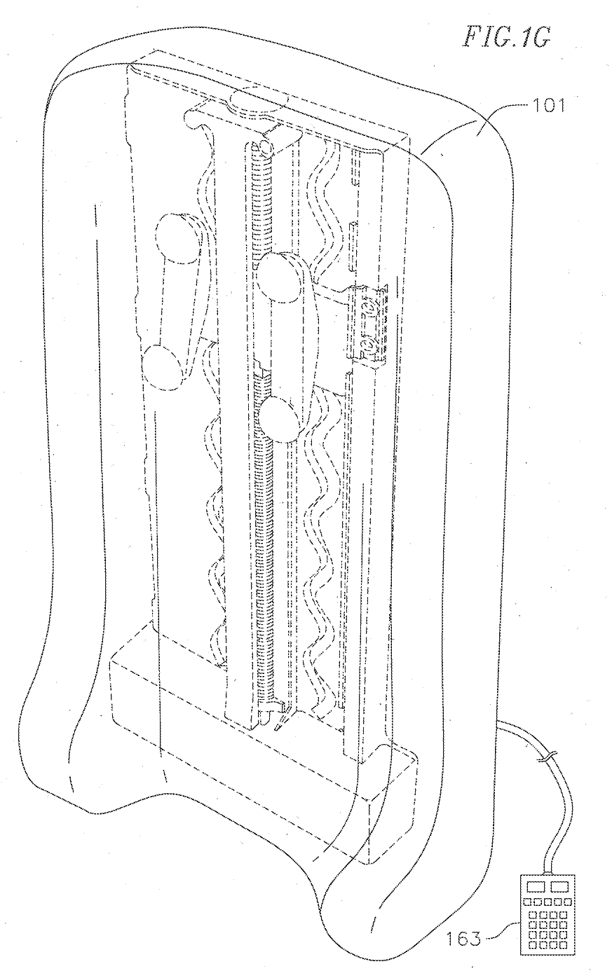

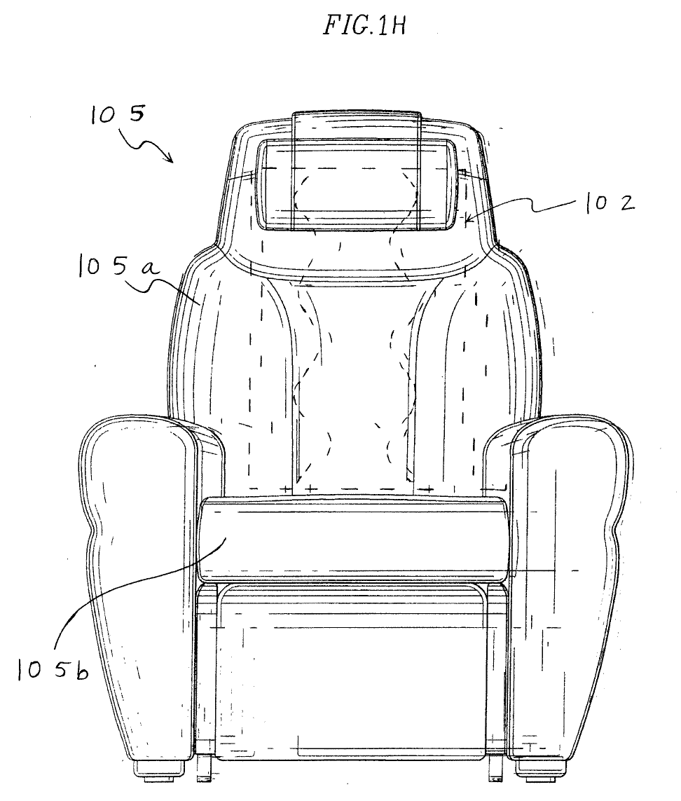

Referring to FIGS. 1A-H, a massaging device 102 according to an exemplary embodiment of the invention includes a main frame 100 with two curved tracks, or snake tracks, 135a and 135b on opposite sides of a drive track 154. The curved tracks 135 each have a plurality of curves forming a snaked pattern. A central mount or carriage 139 is positioned to move along the drive track 154 along a central shaft 106. The central carriage 139 is coupled to two bridges or plates 116a, 116b that extend from the carriage 139 over the snake tracks 135a, 135b. Each bridge 116a, 116b includes a central aperture 118 through which a shaft or mount 155a, 155b extends. The mount 155a, 155b engages the snake track 135a, 135b and follows the curves of the track. Each mount 155a, 155b extends up through the central aperture 118a, 118b of the bridge 116a, 116b to couple to a massage arm 122a, 122b. Two massage heads 195 are attached to opposite ends of each massage arm 122a, 122b. The carriage 139, bridges 116, massage arms 122, massage heads 195, and mounts 155 may be referred to collectively as the massage assembly 104. The massage heads 195 are coupled to the massage assembly 104 such that the movement of the massage assembly along the curved track causes a corresponding movement of the massage head that correlates to the curved pattern of the curved track 135.

As the carriage 139 moves along the shaft 106, the mounts 155 follow the curves of the tracks 135, causing the massage arms 122 to twist back and forth, rotating about the central apertures 118. Thus, each arm 122a, 122b moves the massage heads 195 in a back and forth semi-circular arc A, as shown in FIG. 1D. The movement of the carriage 139 thus translates into a swiveling, semi-circular movement of the massage heads 195 back and forth as the mounts 155 follow the curves of the tracks 135. The mount 155 engages the curved track 135 such that movement of the mount along the curved track translates into a movement of the massage heads 195 that depends on the plurality of curves of the curved track. In some embodiments, the movement of the massage heads 195 directly corresponds to the plurality of curves of the curved track, and in other embodiments the movement of the massage head indirectly corresponds to the curves.

In operation, the massage mechanism 102 provides both kneading and rolling massages. The movement of the mounts 155 along the curves of the snake tracks 135 moves the massage heads 195 in a back and forth kneading motion. The movement of the carriage 139 up and down the drive track 154 moves the massage heads 195 in an up and down rolling motion. Thus, the massage device 102 provides a combined kneading and rolling massage action without employing a motor in the carriage 139 to rotate or twist the massage heads 195. This massage device 102 is therefore simpler than prior art devices that require at least a second motor in the carriage to rotate or spin the massage heads.

In one embodiment, the two curved tracks 135 are positioned to line up on opposite sides of a person's spine, so that the massage heads 195 perform their massaging action on the person's back on either side of the spine. The curved tracks 135 can be curved in any pattern to provide a desired massage effect. The curves shown in FIGS. 1A-1F are symmetrical about an axis, but they need not be. They may include a wide curve followed by a narrower curve, or two large curves followed by two small ones, or various curves offset from the axis. The two tracks 135a, 135b may be parallel to each other or arranged as mirror-images of each other (as shown in FIG. 1E). The arrangement and shape of the curves can be chosen based on the anatomy of the user and the areas where massaging action is desired. The curves can be designed to follow a three-dimensional shape, or they can lie within a two-dimensional plane.

As described above, the mount 155 extends from the massage arm 122 through the aperture 118 in the bridge 116 into the curved track 135. The mount 155 may be shaped as a wheel, a post, a ball, or any other suitable shape for engaging the curved track 135. The curved track 135 may likewise be shaped to receive the mount, for example, by including grooves that retain the mount within the track. The track may be greased to reduce friction between the mount and the sides of the track. Ball bearings can also be used to reduce friction between the mount 155 and the track 135.

A threaded shaft 106 is provided to move the carriage 139 up and down along the drive track 154. The threaded shaft 106 is positioned along the length of the drive track 154. The central mount 139 has internal threads (not shown) that engage external threads 114 of the threaded shaft 106. The threaded shaft 106 is coupled to a motor 157 inside a housing 112 at one end of the main frame 100 (see FIG. 1D). The motor 157 rotates the threaded shaft 106, and the rotating external threads 114 of the shaft 106 engage the carriage 139, causing it to move along the shaft 106. The housing 112 and/or frame 100 may be partially translucent for visibility of internal components, such as the motor 157.

Although a threaded shaft 106 is shown in the figures as the drive mechanism moving the carriage up and down the drive track 154, any other suitable driving mechanism may be used. For example, the carriage 139 may be moved along the drive track 154 by a belt, a pulley, a cable, and/or a toothed gear and toothed drive track. Additionally, the motor 157 is shown located within the housing 112 at one end of the frame 100, but it may be located on the carriage 139, or at any suitable location along the frame 100.

The massaging device 102 includes a stopper 124 at an end of the main frame 100, opposite the housing 112. The main frame 100 also includes one or more electrical switches 126 positioned alongside the snake track 135. As best seen in FIGS. 1A and 1C, a side edge 117 of the bridge 116 is positioned to contact the switches 126 as the bridge 116 moves up and down the frame 100. When the side edge 117 contacts the last switch 126a closest to the stopper 124, the switch 126a sends a signal to control circuitry 161 within the housing 112 to reverse the direction of the motor 157. The massage assembly 104 will then move back along the curved tracks 135 in the opposite direction, back toward the housing 112. The motor simply reverses direction, rotating the threaded shaft 106 in the opposite direction, in order to move the central mount 139 in the opposite direction down the drive track 154.

In one embodiment, the massage device 102 is positioned in a massage cushion or pad 101, as shown in FIG. 1H. The user places the pad 101 in a conventional chair and leans back against the pad 101, which supports the massage device 102. The massage device is positioned such that the user's back contacts the massage heads indirectly, through the fabric or covering of the pad 101. A cover strip 128 (shown in FIG. 1D) is located over the shaft 106 for the comfort of the user, so that the user's spine does not press against the spinning shaft 106. As shown in FIG. 1F, in one embodiment, the massage head 195′ may include a spring 144′ between the massage head and the massage arm 122′ in order to provide some cushioning to the user when the user presses his or her back against the massage heads. The spring 144′ is optional, and is not employed in other embodiments.

In another embodiment, the massage device 102 is positioned in a massage chair 105, as shown in FIG. 1H. The massage chair 105 has a backrest portion 105a and a seat portion 105b. The user sits on the seat portion 105b and rests his or her back against the backrest portion 105a, which supports the massage device 102. Thus, the massage device 102 may be positioned in the back of a complete massage chair, or it may be positioned in a portable backrest cushion or pad which a user can move between multiple chairs, or it may be a standalone device.

The components of the massage device 102 can be made of any suitable material. In one embodiment, the shaft 106 is metal, and the remaining components are made of a lightweight polymeric material.

In one embodiment, the massage arm 122 with massage heads 195 are removable and replaceable with a different massage arm having different massage heads. In this way, the massage device can be used for many different types of massages, with different shaped and sized massage heads spaced in any desired way on the massage arm 122. As shown in FIG. 1D, in one embodiment the massage heads 195 are located on opposite ends of the massage arms 122a, 122b. The placement of the massage heads on the ends of the massage arms maximizes the distance that the massage heads travel through their semi-circular arc A (see FIG. 1D), by increasing the radius r (see FIG. 1A) of the semi-circular rotation. The massage heads 195 rotate about the center of the massage arms 122a, 122b, where the mount 155 extends through the aperture 118 in the bridge 116 and connects to the massage arm. Accordingly, the massage heads will rotate about a smaller radius if they are placed nearer to the center of the massage arm 122, and will rotate about a larger radius if they are placed farther from the center. The longer radius will cause the massage heads to pass through a longer arc as they rotate back and forth. The placement of the massage heads 195 on the arms 122 can be chosen based on the desired massage effect. Furthermore, while the massage heads 195 are depicted as domes, they may be wheels, balls, or any other suitable shape.

The angle a of the arc A (see FIG. 1D) can also be controlled by varying the angle β through which the track 135 curves. A smaller angle P will produce a smaller angle a. If the track 135 is symmetrical, a will be equal to twice β.

As best seen in FIG. 1C, the massage arms 122 on opposite sides of the drive track 154 need not be symmetrically positioned. They may move symmetrically, if desired, but they may also be offset from each other. In FIG. 1C, the first massage arm 122a is initially positioned approximately parallel to the drive track 154, while the second massage arm 122b is initially positioned at an angle to the drive track. The relative angles of these two massage arms 122 may be selected by the user or adjusted to achieve the desired massaging motion as the massage arms twist back and forth.

The housing 112 also houses electrical control circuitry 161 (see FIG. 1D) electrically coupled to the motor 157. The circuitry 161 controls the speed and direction of the motor 157 to control the movement of the carriage 139 along the drive track 154. For example, the circuitry 161 could program the motor 157 to move the carriage 139 only along the lower portion of the drive track 154, to provide a lower back massage for the user. The circuitry 161 could also program the motor 157 to move the carriage 139 along the entire drive track 154, to provide a full back massage. In one embodiment, a control device 163 is provided to allow the user to specify the massage program he or she desires. The control device 163 includes input buttons for the user to input commands, which the control device 163 sends to the circuitry 161 to operate the motor 157.

The massage device 102 also includes an assembly cap 132a, 132b (see FIG. 1C) on opposite sides of the two curved tracks. These caps facilitate installation of the massage assembly 104 into the frame 100. After the massage assembly has been inserted into the frame, the caps 132a, 132b are placed as shown in FIG. 1C to lock the massage assembly into the frame. The caps can be removed in order to remove, repair, or replace the massage assembly.

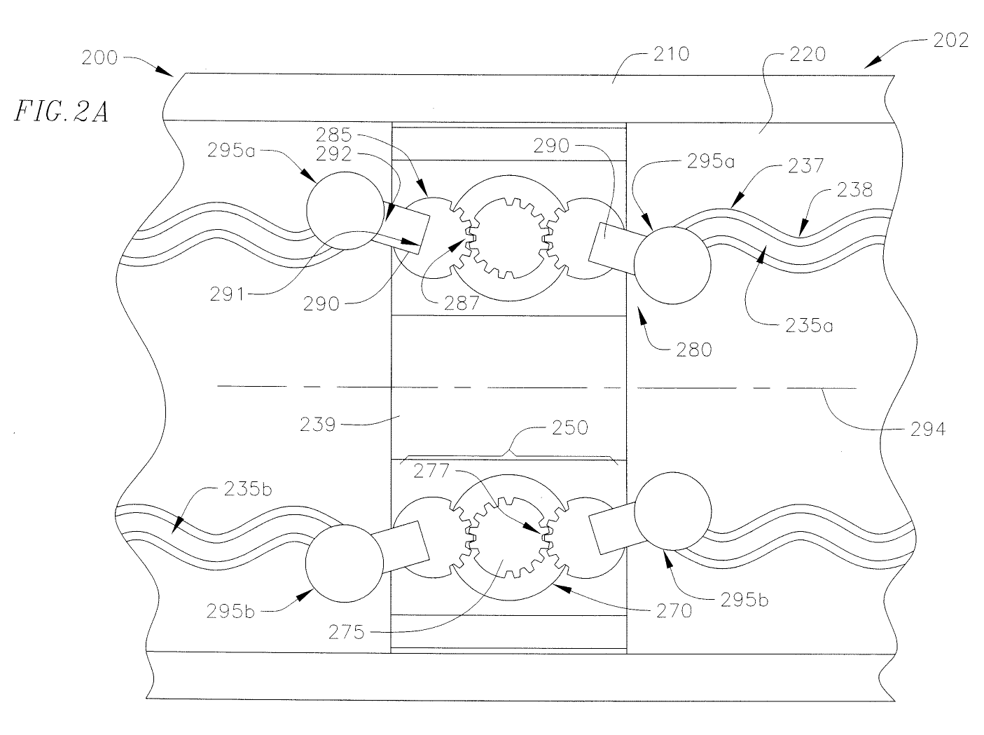

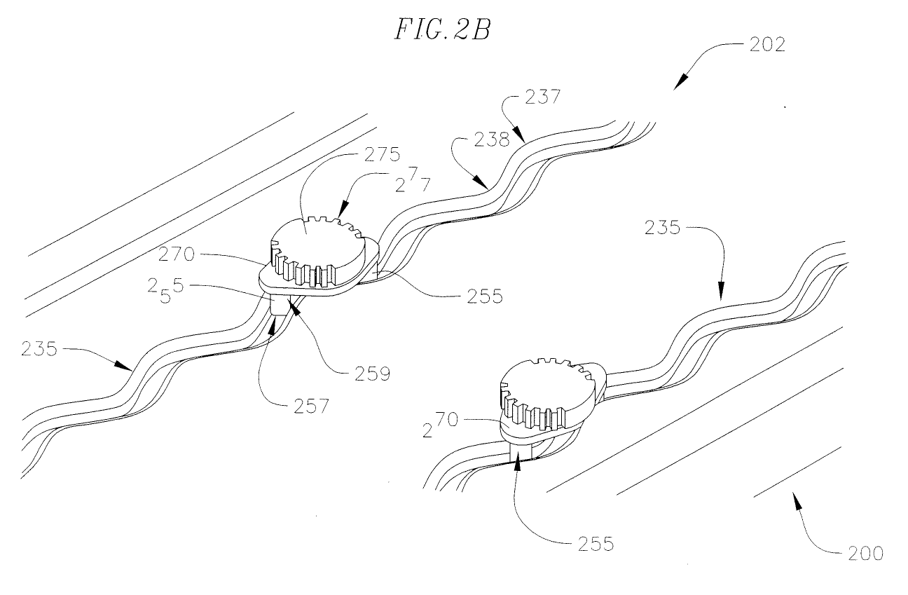

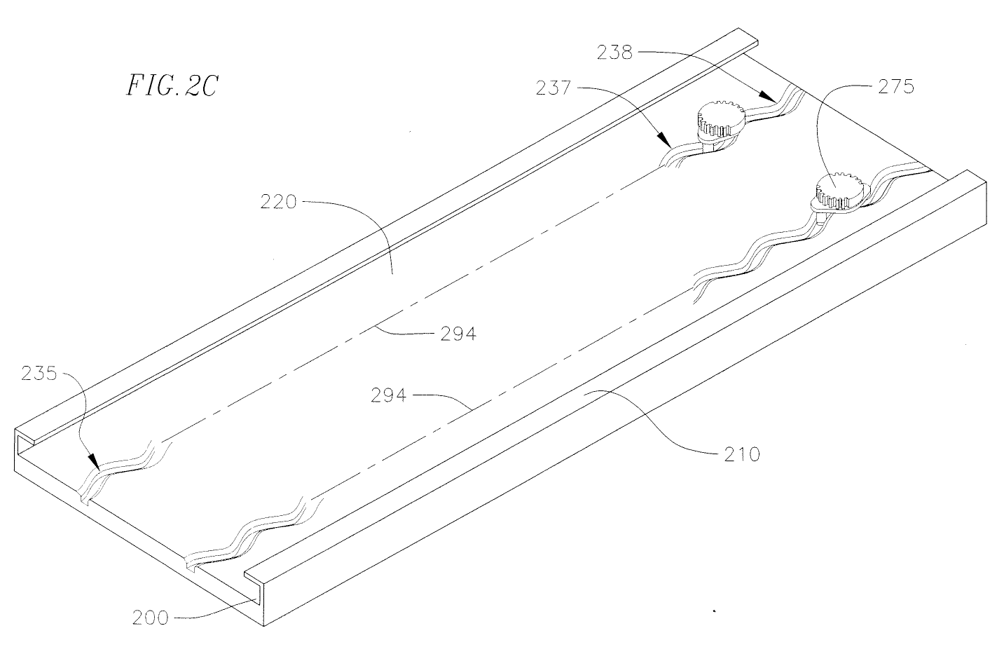

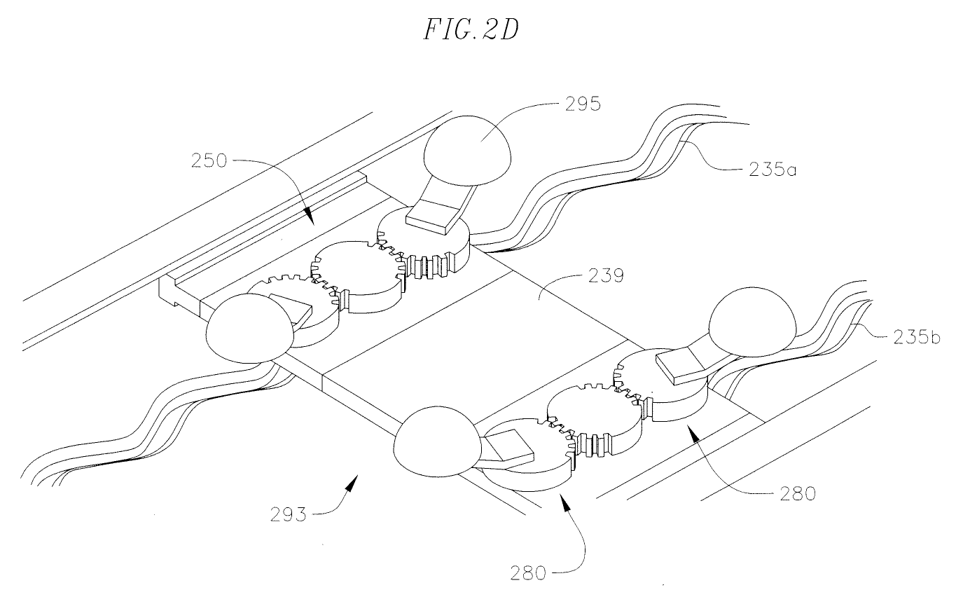

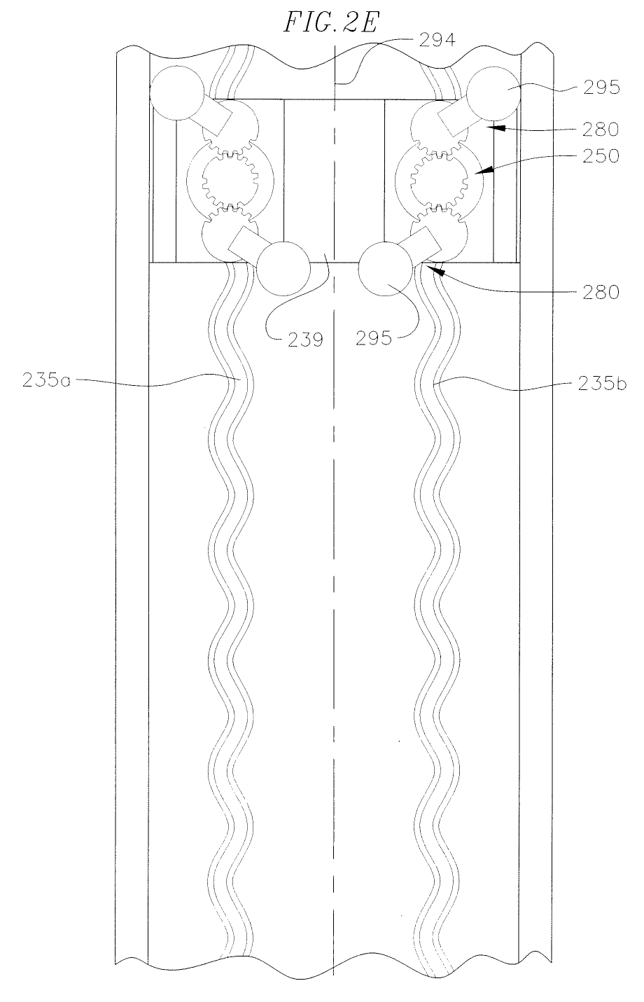

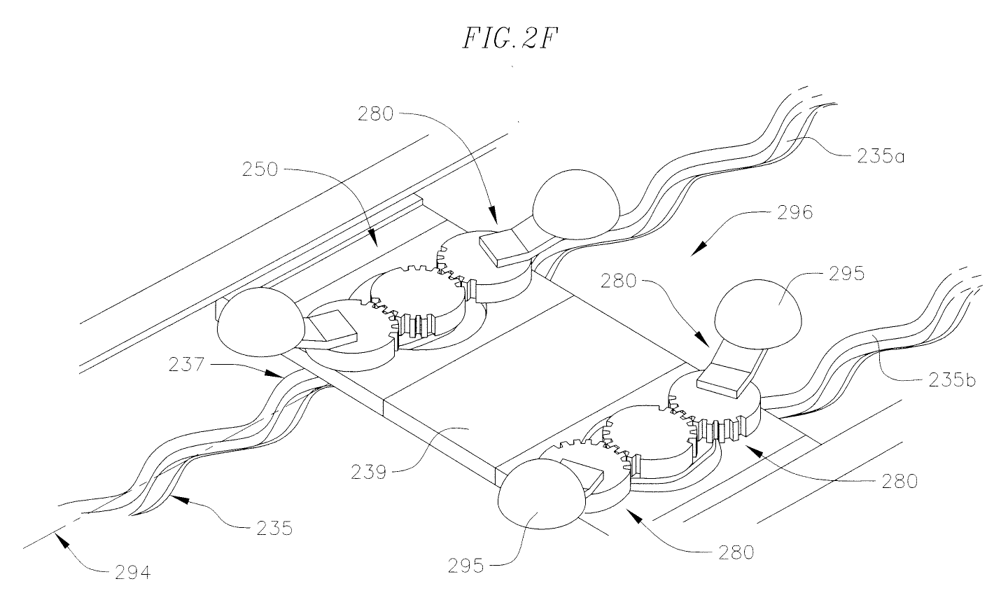

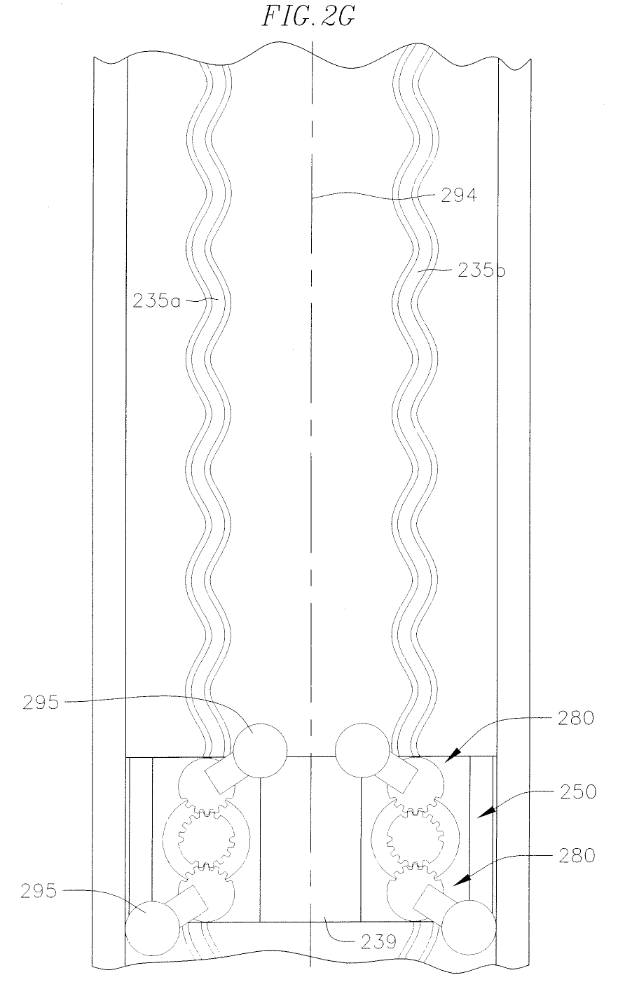

A massage device 202 according to another embodiment of the invention is shown in FIGS. 2A-2G. The massaging device 202 comprises a frame 200, including an outer support frame 210 and an inner support frame 220. The frame 200 also includes two curved or snaked tracks 235a, 235b, each with at least one hill 237 and at least one valley 238. Two gear drive mechanisms 250 engage the snake tracks 235. These gear drive mechanisms 250 move along the snake tracks 235, moving in and out of the hills and valleys of the track. Each gear drive mechanism is further coupled to two massage heads 295 (absent in FIGS. 2B and 2C for clarity). As the gear drive mechanisms 250 moves in and out of the valleys 238 and hills 237, it rotates, causing a corresponding rotation of the massage heads 295. This movement of the massage heads 295 provides a massaging action. The massaging device 202 can perform kneading actions as a result of the movement of the massage heads 295.

Referring to FIGS. 2A-2C, each gear drive mechanism 250 includes a main gear 275 coupled to a main gear bracket 270, which is coupled to at least one mount 255. A first lower end 257 of the mount 255 is slidably coupled to the snake track 235 to follow the curves of the track. A second upper end 259 of the mount 255 is coupled to the main gear bracket 270. The main gear 275 has main gear teeth 277. As the first end 257 of the mount 255 follows the snake track 235, it will rotate the main gear 275 to the right and left as the mount 255 moves in and out of the valleys and hills.

The mounts 255 may slidably engage the tracks 235, and/or they may include wheels, bearings, or rollers that follow the track. For example, in an embodiment, the track 235 and mounts 255 each include mating teeth. A motor coupled to the main gear bracket 270 rotates the mounts 255, causing them to move throughout the teethed track. As another example, in an embodiment a single mount follows the track 235, the gear system further having a means for controlling the rotation of the main gear, such as a motor coupled to the gear and the frame.

In an embodiment, the snake track 235 comprises one or more grooves along the inner support frame 220. Optionally, the track 235 may be replaceable for a specific massage direction, intensity, or location. One snake track may be removed from the inner frame 220 and a second track fitted in to place to provide a different desired massage. In an embodiment, multiple paths along the snake track permit the gear drive mechanism to follow alternate paths. Mechanical or electronic controls or switches may control the path that the gear drive mechanism 250 follows. In the embodiment shown, the snake tracks 235a, 235b are curved about an axis that is parallel with the axis 294 of the drive track.

Referring to FIG. 2A, the gear drive mechanisms 250 are coupled to a center mount 239 positioned between the two snake tracks 235. The center mount 239 and gear drive mechanisms 250 may be moved along the track by a motor mounted at an end of the track and coupled to a gear and pulley drive system. In another embodiment, the gear drive mechanisms 250 are operably coupled to a compressible spring, elastic, or band. As the spring, elastic, or band is wound or stretched, a tension is created which is regulated and released to move the gear drive mechanism 250 through the track. Alternatively, a threaded shaft may be employed to move the center mount 239, as described above.

The rotation of the main gear 275 is caused by the movement of the gear drive mechanisms 250 in and out of the hills 237 and valleys 238 of the snake track 235. The massage heads 295 are coupled to the gear drive mechanism 250 so that they rotate and move along with the gear drive mechanism 250. One or more massage arms 280 are coupled to each gear drive mechanism 250. The massage arms 280 comprise an arm gear 285 rotatably coupled to the main gear 275 with arm gear teeth 287 engaging the main gear teeth 277. The massage arm 280 further comprises a massage arm bracket 290 having a first end 291 and a second end 292, the first end 291 being coupled to the arm gear 285 and the second end 292 being coupled to the massage head 295. In an embodiment, the massage head 295 further includes a motor, heater, vibrator, spring, and/or a multi-axis positional adjustment. The massage heads 295 are replaceable with alternate attachments such as a ball, wheel, roller, or kneader attachment. A rolling attachment is also capable of an up/down action and includes a spring and intensity adjustment. The up/down drive may be a simple screw or chain drive.

In an embodiment, the gear drive mechanism 250 begins at a point along the snake track 235 and moves in a direction parallel to the axis 294 of the track. As the gear drive mechanism 250 moves along the snake track 235, the mounts 255 follow the track 235. Where the snake track 235 is straight, the mounts 255 move along the axis 294 of the track along the direction of the axis 294. But where the track 235 is curved, the mounts 255 follow the track, moving in a direction that is angled, offset from, or even perpendicular to the axis 294 of the track 235. That is, the mounts 255 will move in and out of the hills and valleys of the snake track 235, moving to the left and right of the main axis of the track.

In one embodiment, each gear drive mechanism 250 includes two mounts 255 on opposite ends of the main gear bracket 270, on a bottom side of the main gear bracket (see FIG. 2B). When the mounts 255 are spaced apart, the rear mount will follow the movements of the front mount, but with a delay. Consequently, as the gear drive mechanism 250 moves through the snake track 235, the mounts 255 will move at angles offset from the axis of the track, and may move in opposite directions to each other. For example, the front mount may move to the right of the axis 294 of the track 235 while the rear mount moves to the left of the axis. The result of this movement is that the main gear bracket 270 will partially rotate to follow the mounts 255 as the front mount approaches a hill of the track while the rear mount approaches a valley. As the main gear bracket 270 partially rotates, the main gear 275 will also partially rotate. The rotation of the main gear 275 causes the arm gears 285 to rotate, since the arm gears engage the main gear through the arm gear teeth 287 and main gear teeth 277. Thus, as the mounts 255 follow the track, the main gear bracket 270, main gear 275, and arm gears 285 rotate, thereby moving the massaging heads 295. The arm gear teeth 287 of the two massage heads 295 engage the main gear teeth 277 at opposite ends of the main gear bracket 270 on a top side of the main gear bracket, opposite the bottom side with the two mounts 255.

In one embodiment, the main gear teeth 277 interlock with the arm gear teeth 287. As the main gear 275 rotates in one direction, the arm gear 285 will rotate in the opposite direction. The size of the main gear 275, the size of the arm gear 285, and/or the spacing of the teeth 277, 298 are adjustable to change the speed and force of the rotation. In an embodiment, a pulley or chain mechanism is used to transfer the rotational torque to the arm gear 285. As the arm gear 285 rotates, the massage arm 280 will track the movement, causing the massage head 295 to move in a semicircular direction about the axis of rotation of the arm gear 285. Therefore, as the gear drive mechanism 250 moves along the snake track 235, the massage head 295 will move parallel to and at an angle to the axis 294 of the track, simulating a massage. By adjusting the period between hills or valleys, the degree and speed of rotation of the massaging heads 295 as a ratio to the speed the main gear 275 can be adjusted.

This movement of the massaging heads is illustrated in FIGS. 2D-2G. In FIGS. 2D and 2E, the massage arms 280 and massage heads 295 are shown in a first position 293 relative to the axis 294 of the track 235. In this position, the massage heads 295 at the top of the carriage 239 are, pointed away from each other, while the massage heads at the bottom of the carriage 239 are pointing towards each other. As the gear drive mechanism moves from a hill 237 to a valley 238, the massage arms 280 and massage heads 295 approach a second position 296, shown in FIGS. 2F and 2G, where the massage heads 295 at the top of the carriage are pointed toward each other, and the massage heads at the bottom of the carriage are pointed away. Thus, as the gear drive mechanism moves from a hill to a valley or a valley to a hill, the massage arms change position, moving back and forth between the first and second positions shown in FIGS. 2D-2G.

In an embodiment the massage mechanism may include an electronic control system, including a control interface or computer USB connection to allow repositioning of the track, speed adjustment, and a program to adjust the movements of the device. The electronic control system may be a hand-held controller with buttons or controls that receive user inputs, so that the user can select the type of massage to be performed.

In an embodiment, further provided is a method of using the massage mechanism comprising electrically or mechanically winding or adding torque to the system to drive the massage mechanism, actuating a switch to enable the massage mechanism, and programming a control system to select the path that the massage mechanism will follow or the speed or intensity of movement.

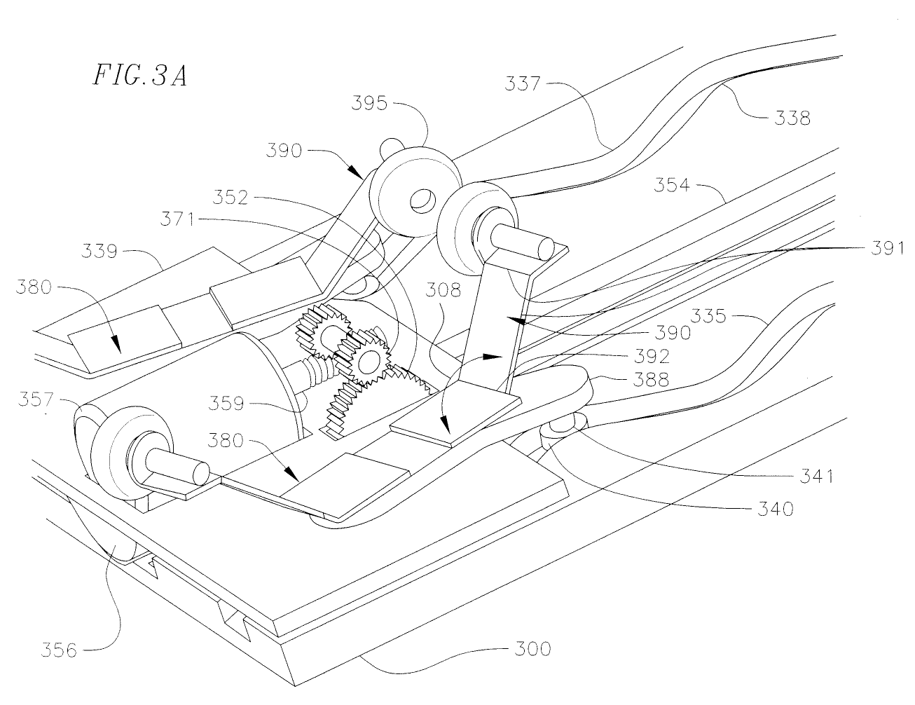

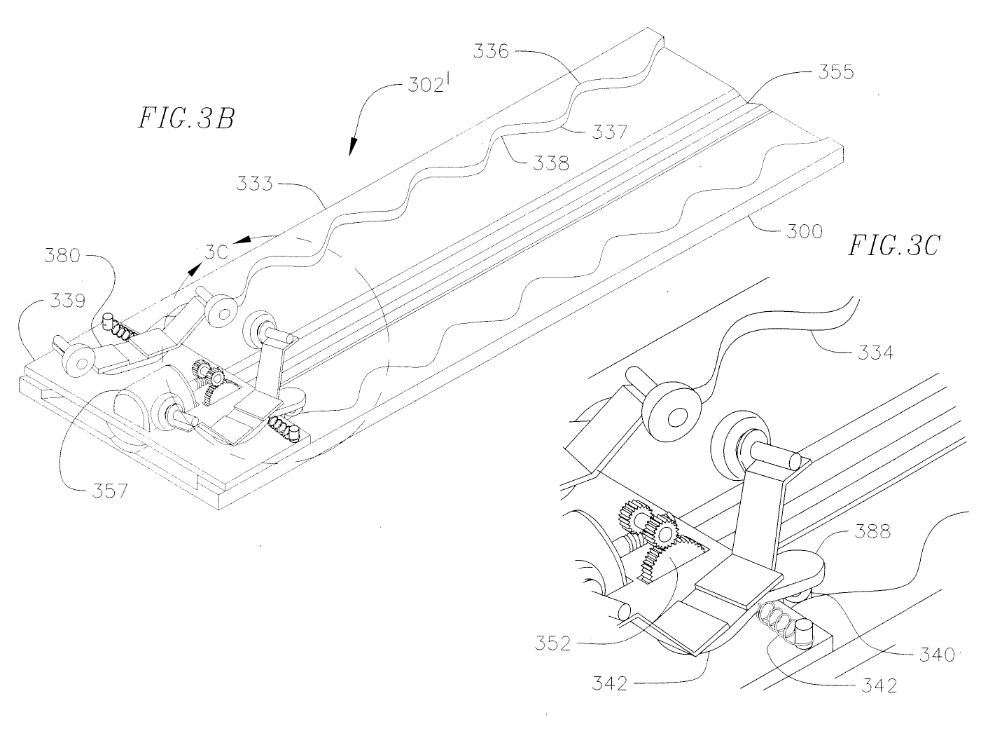

A massaging device 302 according to another embodiment of the invention is shown in FIG. 3A. In this embodiment, the massaging device 302 comprises a main frame 300, which includes a drive track 354 and at least one snake track 335. The snake track 335 and drive track 354 can be formed as grooves along the main frame 300. In the embodiment shown, the axes of the snake track and drive track are parallel.

A carriage 339 is slidably coupled to the main frame 300 by a carriage guider 356 that slidably follows the drive track 354. The carriage 339 is rotatably coupled to at least one massage arm 380. A massage arm support 388 couples the massage arm 380 to a massage arm bracket 390 which is connected to the massage head 395. This massage arm bracket 390 may have a bend, curve, or angle 308 to position the massage head 395 closer to the user. The massage arm 380 is further coupled to the snake track 335 by way of a mount 340 and mount support 341. The mount 340 may be rotatably and/or slidably coupled to the snake track 335.

The carriage 339 moves along the drive track 354 in the center of the main frame 300. A motor 357 powers a rotating shaft 359 that rotates a secondary gear 371 that rotates a carriage drive 352. The carriage drive, for example, may be a gear with teeth that interlock with corresponding teeth (not shown) in the drive track 354. In other embodiments, the carriage 339 may slide along the drive track 354 instead of engaging teeth in the drive track.

For example, in an embodiment, the motor 357 operably moves the carriage 339 along the drive track 354. As the carriage moves, the mounts 340 follow the snake track 335. As the mounts move, the massage arms 380 move. The massage head 395, being coupled to the massage arms 380, will follow the movement of the hills and valleys of the snake track 335.

A massaging device 302′ according to another embodiment of the invention is shown in FIGS. 3B-3C. The massaging device 302′ includes a main frame 300 with a drive track 354 and at least one side snake track 336. In an embodiment, the side snake track 336 extends outwardly from the main frame 300. The side snake track 336 can be formed as an edge 334 of an outer support 333. The side snake track 336 includes only one edge, such as edge 334, rather than two opposite edges that form a groove between them. The side snake track 336 includes hills 337 and valleys 338. Alternatively, a single track can function as both the drive track and the snake track, such as, for example, a straight drive track with curved edges having hills and valleys.

A carriage 339 is movably coupled to the main frame 300. The carriage 339 is rotatably coupled to at least one massage arm 380. The massage arm 380 is coupled to the side snake track 336 by a mount 340. The mount 340 can be rotatably and/or slidably coupled to the side snake track 336. The massage arm 380 may be coupled to the side snake track 336 in a variety of ways. For example, in an embodiment, a drive pin couples the massage arm 380 to the side snake track 336. Alternatively, or in addition, a bearing can be used to couple the massage arm 380 to the side snake track 336. In the embodiment shown, a spring 342 operably applies pressure to the massage arm support 388 to bias it against the side snake track 336. For example, the spring 342 may be located along the massage arm support 388, such that force applied by the spring is converted into a force between the massage arm support and the side track. The spring could either push the mount against the side snake track 336, or pull it up against the side snake track (as shown in FIGS. 3B-3C). The side snake track 336 may also include a stop or lip to prevent the mount 340 from leaving the track.

In many embodiments, the carriage 339 slidably moves along the drive track 354. A motor 357 operably drives a carriage drive 352 to move the carriage 339 along the drive track 354. As the carriage 339 moves, the massage arm support 388 moves adjacent to the side snake track 336. As the massage arm support 388 approaches a hill in the side snake track, one of the massage arms moves inward toward the drive track 354. As the massage arm support approaches a valley in the side snake track, one of the massage arms moves outward toward the side snake track. The inward and outward motion of the massage arms provides a massaging action.

In an embodiment, the side snake track 336 includes adjustable hills and valleys. For example, hills may be steeper to generate more motion of the massage arms 388. The side snake track 336 may be removable and replaceable with different tracks having different shaped hills and valleys to provide a different massage action.

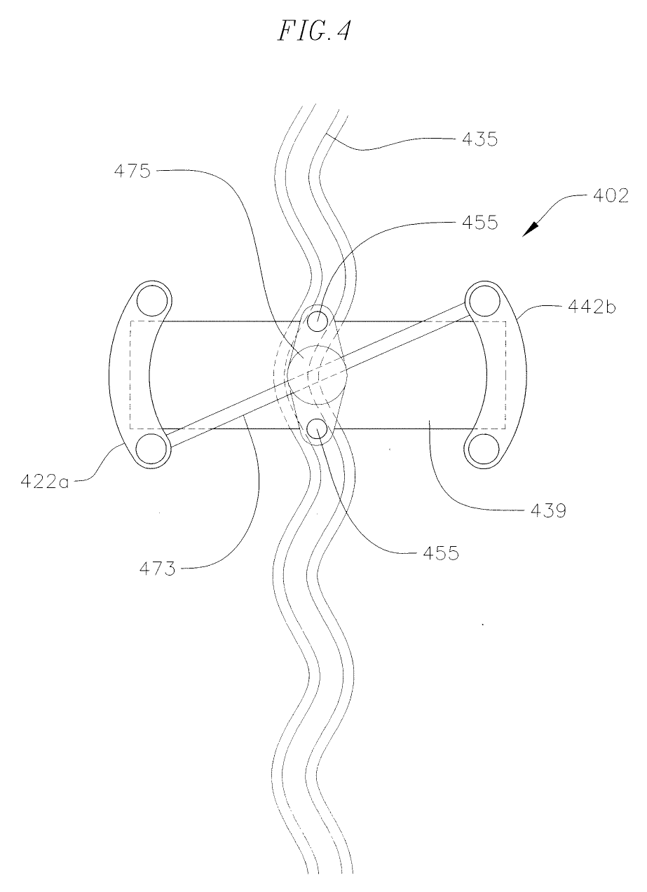

In another embodiment of the invention, shown in FIG. 4, a massage device includes only one curved track along the center of the device, rather than two curved tracks on opposite sides of the center. A central mount or carriage 439 moves along the curved track 435 and includes two mounts or wheels 455 extending below the carriage and engaging the curved track 435. The two wheels 455 are connected to a central gear 475 which rotates back and forth as the wheels 455 pass through the curves of the track. The central gear 475 is in turn connected to a connecting rod 473 that rotates with the gear. The rod is connected at opposite ends to opposite massage arms 422a, 422b. The rotation of the gear 475 causes the rod 473 to rotate, moving the massage arms back and forth in semicircular rotations, providing a kneading and rolling massaging action, as described before. As this embodiment demonstrates, the massage device 402 can operate with a single curved track 435 rather than two curved tracks. Furthermore, the mount 455 engaging the curved track may include a single mount, or two mounts, such as the two wheels 455 shown in FIG. 4.

When the rod 473 is connected diagonally as shown in FIG. 4, the massage heads move in a kneading motion. However, the rod 473 could alternatively be connected straight rather than diagonally, to produce a parallel movement of the massage heads.

Although limited embodiments of a kneading and rolling robotic massage device have been specifically described and illustrated herein, many modifications and variations will be apparent to those skilled in the art. Accordingly, it is to be understood that the massage device constructed according to principles of this invention may be embodied other than as specifically described herein. The invention is also defined in the following claims.

What is claimed is:

1. A massaging apparatus comprising:
a frame having a curved track including a plurality of curves;
a mount engaging the curved track;
a massage head coupled to the mount; and
a motor adapted for moving the mount along the curved track, wherein the mount engages the curved track such that movement of the mount along the curved track translates into a movement of the massage head that depends on the plurality of curves of the curved track.

2. The massaging apparatus of claim 1, wherein the movement of the massage head directly corresponds to the plurality of curves of the curved track.

3. The massaging apparatus of claim 1, further comprising a carriage coupled to the mount, wherein the frame further comprises a drive track, and wherein the carriage is movable along the drive track.

4. The massaging apparatus of claim 3, further comprising a threaded shaft positioned along the drive track and coupled to the motor and the carriage for movement of the carriage along the drive track.

5. The massaging apparatus of claim 3, further comprising a bridge connecting the carriage and the mount, and further comprising a massage arm coupling the mount to the massage head.

6. The massaging apparatus of claim 5, wherein the mount extends through an aperture in the bridge to connect to the massage arm.

7. The massaging apparatus of claim 5, further comprising a second massage head, and wherein the massage heads are positioned at opposite ends of the massage arm.

8. The massaging apparatus of claim 1, further comprising a gear connected to the mount, the gear having gear teeth, and wherein the massage head comprises massage head teeth engaging the gear teeth.

9. The massaging apparatus of claim 8, further comprising a second mount and a second massage head having massage head teeth, and wherein the two mounts are connected to the gear at opposite ends of the gear on a first side of the gear, and wherein the massage head teeth of the two massage heads engage the gear teeth at opposite ends of the gear on a second side of the gear opposite the first side.

10. A massaging apparatus comprising:
a frame comprising a curved track having a curved pattern;
a massage assembly coupled to a massage head; and
a motor coupled to the massage assembly to move the massage assembly along the curved track,
wherein the massage assembly and the massage head are coupled together such that the movement of the massage assembly along the curved track causes a corresponding movement of the massage head that correlates to the curved pattern of the curved track.

11. The massaging apparatus of claim 10, wherein the movement of the massage head directly correlates to the curved pattern of the curved track.

12. The massaging apparatus of claim 10, wherein the frame further comprises a second curved track and a drive track between the two curved tracks, and wherein each of the two curved tracks and the drive track has an axis, and wherein the three axes are parallel.

13. The massaging apparatus of claim 12, further comprises a threaded shaft coupled to the motor and the massage assembly to move the massage assembly along the drive track.

14. The massaging apparatus of claim 12, further comprising a second mount engaging the second curved track and a second massage head coupled to the second mount, and further comprising a first bridge coupling the mount to the massage assembly and a second bridge coupling the second mount to the massage assembly.

15. A massage pad comprising:
a pad;
a frame having a curved track including a plurality of curves, wherein the pad supports the frame;
a mount engaging the curved track;
a massage head coupled to the mount; and
a motor adapted for moving the mount along the curved track, wherein the mount engages the curved track such that movement of the mount along the curved track translates into a movement of the massage head that depends on the plurality of curves of the curved track.

16. The massaging apparatus of claim 15, wherein the plurality of curves forms a snake track.

17. The massage apparatus of claim 15, further comprising a second curved track, a second mount, and a second massage head, wherein each mount engages one of the curved tracks and is coupled to one of the massage heads.

18. The massage apparatus of claim 15, wherein the plurality of curves comprises curves that are symmetric about an axis.

19. A massage chair comprising:
a backrest portion;
a seat portion;
a frame comprising a curved track having a curved pattern, wherein the backrest portion supports the frame;
a massage assembly coupled to a massage head; and
a motor coupled to the massage assembly to move the massage assembly along the curved track,
wherein the massage assembly and the massage head are coupled together such that the movement of the massage assembly along the curved track causes a corresponding movement of the massage head that correlates to the curved pattern of the curved track.

20. The massaging apparatus of claim 19, wherein the massage assembly further comprises a carriage and a bridge connecting the carriage to the mount.

21. The massaging apparatus of claim 19, further comprising a second curved track having a second curved pattern, wherein the two curved tracks are mirror images of each other.

22. The massaging apparatus of claim 19, wherein the curved track comprises a plurality of snaked curves.

23. A massaging apparatus comprising:
a frame having a massage track;
a massage assembly engaging the massage track and having at least one massage head;
means for moving the massage assembly along the massage track in a first direction; and
means for rotating the massage head in a second direction offset from the first direction.

24. The massaging apparatus of claim 23, wherein the means for rotating comprises a plurality of curves in the massage track and a mount connected to the at least one massage head and engaging the plurality of curves to translate the plurality of curves into rotation of the massage head.

25. The massaging apparatus of claim 23, wherein the means for moving comprises a threaded shaft coupled to the massage assembly and coupled to a motor for rotating the threaded shaft to move the massage assembly in the first direction.
